(19) United States
(12) Patent Application Publication
(10) Pub. No.: US 2012/0227467 A1
(43) Pub. Date: Sep. 13, 2012

(54) DEVICE FOR TESTING PRESSURE RESISTANCE OF VESSEL AND METHOD FOR TESTING PRESSURE RESISTANCE OF VESSEL BY USING THE DEVICE

(75) Inventors: Un Bong Baek, Daejeon (KR); Seung Hoon Nahm, Daejeon (KR); Hae Moo Lee, Daejeon (KR); Yun-Hee Lee, Daejeon (KR)

(73) Assignee: KOREAN RESEARCH INSTITUTE OF STANDARDS AND SCIENCE, Daejeon (KR)

(21) Appl. No.: 13/505,010

(22) PCT Filed: Oct. 21, 2010
(86) PCT No.: PCT/KR10/07235

§ 371 Date: May 16, 2012

(30) Foreign Application Priority Data
Nov. 2, 2009 (KR) 10-2009-0104753

(51) Int. Cl. G01M 3/20

(52) U.S. Cl. 73/40.7

(57) ABSTRACT

The present invention relates to a device for testing resist pressure of a vessel wherein gas is stored at a high compressed state, before the use of the vessel, and to a method for testing resist pressure of a vessel by using the testing device. The device includes: the vessel provided as an object to which a resist pressure test is carried out; an elastic tube placed in the interior of the vessel and adapted to fill a liquid into the interior thereof; a pressurizing means adapted to apply a predetermined pressure to the elastic tube to allow the elastic tube to be expanded; and a pressure gauge adapted to gauge the pressure in the interior of the vessel, wherein a gas is filled into the vessel to apply a predetermined pressure to the interior of the vessel by the expansion of the elastic tube.

### TECHNICAL FIELD

The present invention relates to a device for testing resist pressure of a vessel wherein gas is stored at a high compressed state, before the use of the vessel, and to a method for testing resist pressure of a vessel by using the testing device. More particularly, the present invention relates to a device and method for testing resist pressure of a hydrogen-storing vessel by using a small quantity of low pressure gas (especially, hydrogen gas).

### BACKGROUND ART

Gases occupy a relatively large volume, and when they are moved or delivered, they are compressed to a high pressure and stored in a vessel. During the high pressure gases are repeatedly filled into or discharged from the vessel, the vessel is under the repeated load and is thus liable to be broken. Accordingly, the vessel should have predetermined durability and reliability such that no breakdown occurs even under the application of the repeated load thereto.

Furthermore, gases, especially hydrogen gas reacts with metals to cause hydrogen embrittlement (which is the process by which the distances of metal molecules become increased when the hydrogen molecules pass through the metal molecules, so that the strengths of the metal molecules become decreased), and accordingly, a hydrogen (for example, hydrogen combustion engines and hydrogen pipe lines)-storing vessel has to resist hydrogen embrittlement relative to hydrogen. If the vessel is deformed at a high pressure or if hydrogen leakage occurs from the vessel, the vessel is broken or even burst by the occurrence of hydrogen embrittlement.

Accordingly, it is very important to perform a resist pressure test of the vessel. The resist pressure test of the liquid-storing vessel is performed by first filling a liquid into the vessel, by putting an injection liquid thereinto by means of a pressurizing means, and by checking whether the vessel is deformed or not at a predetermined pressure. FIG. 1 is a sectional view showing a device for testing resist pressure of a liquid-storing vessel in a conventional practice, wherein a liquid 20 is filled into a vessel 50 and an injection liquid 210 is put into the vessel 50 by means of a pressurizing means 200. Also, FIG. 2 is a sectional view showing a state wherein a pressure is applied to the vessel 50 after the injection liquid 210 is put into the vessel 50 by means of the pressurizing means 20 in the conventional device of FIG. 1.

If the resist pressure test is performed in the state of filling the liquid (e.g., water) 20 into the vessel 50, in this case, it can be analyzed and measured that what degree of pressure causes the deformation of the vessel 50. However, it cannot be checked that what degree of embrittlement of the vessel 50 occurs with respect to gas (especially hydrogen). Accordingly, it cannot be found that there is a possibility that the vessel may be broken by the occurrence of the embrittlement during the real use thereof.

Moreover, FIG. 3 is a sectional view showing a device for testing resist pressure of a vessel in another conventional practice, wherein, in the same environments as the real use environments thereof, a gas 40 is filled into a vessel 50 and an injection liquid (or an injection gas) 210 is put into the vessel 50 by means of a pressurizing means 200. In case of the testing device 30 as shown in FIG. 3, a testing device 30 has a restriction on the total quantity of the gas 40 (especially hydrogen) having an explosive property in the resist pressure test, such that it is difficult to perform the resist pressure test by using the gas. If the vessel 50 has a defect, furthermore, it may be burst during the resist pressure test. Accordingly, there is a definite need for the development of the device for testing the resist pressure of the vessel, wherein while a quantity of the gas 40 used for the resist pressure test is within a limited predetermined range, the gas 40 is brought into contact with the interior of the vessel 50 and a desired pressure is applied to the vessel 50 during the resist pressure test.

### DISCLOSURE OF INVENTION

### Technical Problem

Accordingly, the present invention has been made in view of the above-mentioned problems occurring in the prior art, and it is an object of the present invention to provide a device and method for testing resist pressure of a gas-storing vessel wherein a small quantity of gas having a high explosive property is used to perform a resist pressure test of the vessel, under the same environment as the real use conditions of the vessel.

It is another object of the present invention to provide a device and method for testing resist pressure of a gas-storing vessel that if a resist pressure test is performed in the state where hydrogen gas is filled into the whole of the interior of a large sized vessel, the vessel may be burst, but according to the present invention an elastic tube is mounted in the interior of the vessel, a small quantity of hydrogen is filled into the remaining space of the vessel not occupied by the elastic tube, thereby removing the danger of explosion of the vessel.

It is a still another object of the present invention to provide a device and method for testing resist pressure of a gas-storing vessel that is capable of applying a pressure to the vessel in the same manners as in the real use conditions thereof even though a small quantity of hydrogen gas is used, and testing a degree of hydrogen embrittlement of the vessel caused by the hydrogen gas.

The above and other objects and features of the present invention will be better understood from the following description of the preferred embodiment with reference to the attached drawings.

### Solution to Problem

To accomplish the above objects, according to an aspect of the present invention, there is provided a device for testing resist pressure of a vessel, the device including: the vessel provided as an object to which a resist pressure test is carried out; an elastic tube placed in the interior of the vessel and adapted to fill a liquid into the interior thereof; a pressurizing means adapted to apply a predetermined pressure to the elastic tube to allow the elastic tube to be expanded; and a pressure gauge adapted to gauge the pressure in the interior of the vessel, wherein a gas is filled into the vessel to apply a predetermined pressure to the interior of the vessel by the expansion of the elastic tube.

According to the present invention, desirably, the gas is hydrogen.

According to the present invention, desirably, the vessel is a hydrogen-storing vessel.

According to the present invention, desirably, the pressurizing means expands the elastic tube by putting an injection liquid into the elastic tube.

According to the present invention, desirably, the elastic tube is formed of a rubber tube, a polymer elastomer, or the like.

According to the present invention, desirably, the pressurizing means comprises a tank adapted to storage the injection liquid to be put into the elastic tube therein, a compressor adapted to compress the injection liquid stored in the tank and to put the injection liquid into the elastic tube, and an injection pipe adapted to connect the compressor and the elastic tube.

According to the present invention, desirably, the injection liquid is an incombustible liquid and does not react with the tank, the compressor, the injection pipe and the elastic tube.

According to the present invention, desirably, the pressure of the compressor is in a range between 1 Mpa and 250 Mpa.

According to the present invention, desirably, the pressurizing means further includes a controller adapted to control the compressor to adjust the pressure in the vessel.

According to the present invention, desirably, a measuring means is connected to the exterior of the vessel to measure and observe the state of the vessel.

According to the present invention, desirably, a detector is connected to the measuring means to perform operation and analysis of a deformation rate and a gas leakage rate of the vessel caused by the pressure of the gas.

According to the present invention, desirably, a cut-off part is provided to cut off the putting operation of the injection liquid into the elastic tube and has a discharge outlet adapted to discharge the injection liquid put into the elastic tube therethrough.

According to the present invention, desirably, if the deformation rate obtained by the operation of the detector is more than a critical deformation rate set previously, and alternatively, if gas leakage occurs, the cut-off part is operated by the controller to stop the putting operation of the injection liquid into the elastic tube.

To accomplish the above objects, according to another aspect of the present invention, there is provided a method for testing resist pressure of a vessel, the method including the steps of: filling a gas into the vessel provided as an object to which a resist pressure test is carried out and placing an elastic tube in which a liquid is stored in the interior of the vessel; connecting the elastic tube and a pressurizing means and putting an injection liquid into the elastic tube by means of the pressurizing means to expand the elastic tube; compressing the gas filled into the vessel to increase a pressure in the interior of the vessel; gauging the pressure in the interior of the vessel by means of a pressure gauge; and repeatedly increasing and decreasing the pressure of the injection liquid in the elastic tube to apply repeated load to the vessel.

According to the present invention, desirably, the gas is hydrogen and the vessel is a hydrogen-storing vessel.

According to the present invention, desirably, in the step of expanding the elastic tube the injection liquid stored in a tank is compressed by means of a compressor and is put into the elastic tube through an injection pipe.

According to the present invention, desirably, the compressor is controlled by means of a controller to adjust the pressure in the interior of the vessel.

According to the present invention, desirably, the step of gauging the pressure in the interior of the vessel further comprises the step of measuring and observing the vessel through a measuring means connected to the exterior of the vessel.

According to the present invention, desirably, the step of gauging the pressure in the interior of the vessel further comprises the step of performing operation and analysis of a deformation rate and a gas leakage rate of the vessel caused by the pressure of the gas through a detector connected to the measuring means.

According to the present invention, desirably, if the deformation rate obtained by the operation of the detector is more than a critical deformation rate set previously, and alternatively, if gas leakage occurs, the putting operation of the injection liquid into the elastic tube stops by means of a cut-off part operated by the controller.

### ADVANTAGEOUS EFFECTS OF INVENTION

According to the present invention, a small quantity of low pressure gas having a high explosive property is used to perform the resist pressure test of the vessel, under the same environments as the real use conditions of the vessel.

Accordingly, if the resist pressure test is performed in the state where a hydrogen gas is filled into the whole of the interior of a large sized vessel, the vessel may be burst, but according to the present invention an elastic tube is mounted in the interior of the vessel, a small quantity of hydrogen is filled into the remaining space of the vessel not occupied by the elastic tube, thereby removing the danger of explosion of the vessel.

Even though a small quantity of low pressure gas is used, further, a desired pressure is applied to the vessel under the same conditions as the real use conditions thereof, and also, it is checked whether gas leakage occurs from the vessel. According to the present invention, the pressurizing means is not directly connected to the vessel, and the elastic tube is mounted in the interior of the vessel, so that the injection liquid is put into the elastic tube to allow the pressure in the interior of the vessel to be increased, thereby making it possible to perform the resist pressure test in more stable state.

Since the pressure in the interior of the vessel is gauged in real time and further adjusted, the resist pressure test can be performed irrespective of the kinds of vessels. Also, the elastic tube is mounted in the interior of the vessel at a low cost, and therefore, it can be widely used in view of economical advantages. Since the mounting of the elastic tube is performed irrespective of the shapes, materials and kinds of vessels, advantageously, the resist pressure test can be performed to all kinds of vessels.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

### BRIEF DESCRIPTION OF DRAWINGS

FIG. 1 is a sectional view showing a device for testing resist pressure of a liquid-storing vessel in a conventional practice.

FIG. 2 is a sectional view showing a state wherein a pressure is applied to the vessel in the conventional device of FIG. 1.

FIG. 3 is a sectional view showing a device for testing resist pressure of a gas-storing vessel in another conventional practice.

FIG. 4 is a sectional view showing a device for testing resist pressure of a vessel according to a first embodiment of the present invention.

FIG. 5 is a sectional view showing a state wherein an injection liquid is put into an elastic tube in the testing device of FIG. 4.

FIG. 6 is a sectional view showing a device for testing resist pressure of a vessel according to a second embodiment of the present invention.

FIG. 7 is a flow chart showing a method for testing resist pressure of a vessel according to a preferred embodiment of the present invention.

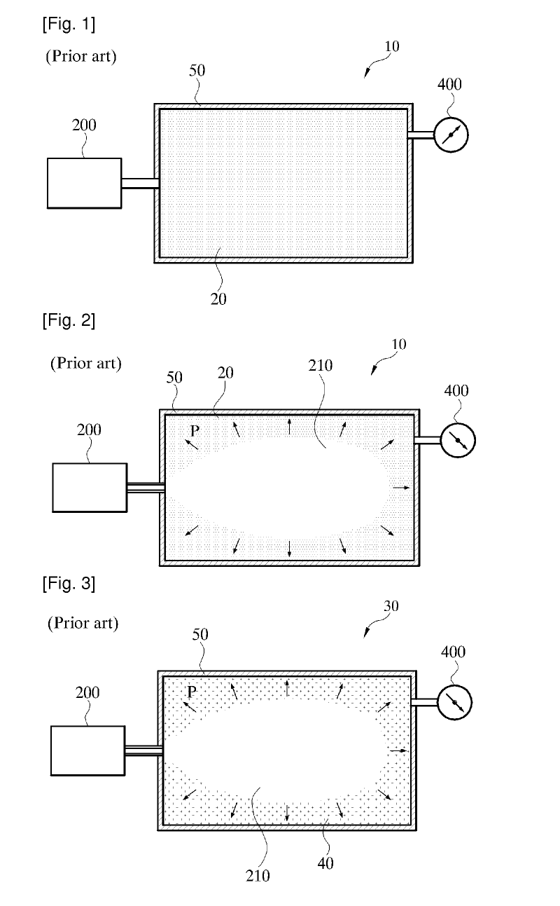

### MODE FOR THE INVENTION

Hereinafter, an explanation on the preferred embodiments of the present invention which are easily understood to those skilled in the art will be in detail given with reference to the attached drawings. In the preferred embodiments of the present invention, it is noted that a detailed explanation on the functions and structures of generally known components or parts will be avoided for the brevity of the description.

Also, in the preferred embodiments of the present invention, it is noted that the same components and parts as each other are denoted by the same reference numerals in the drawing. In the description of the preferred embodiment, if one part is connected to another part, it means they are indirectly connected to each other by interposing a part therebetween as well as they are directly connected to each other. Also, a word including a part is understood as a more comprehensive concept including other parts only if specific description is not mentioned.

<Configuration of a Device for Testing Resist Pressure of a Vessel>

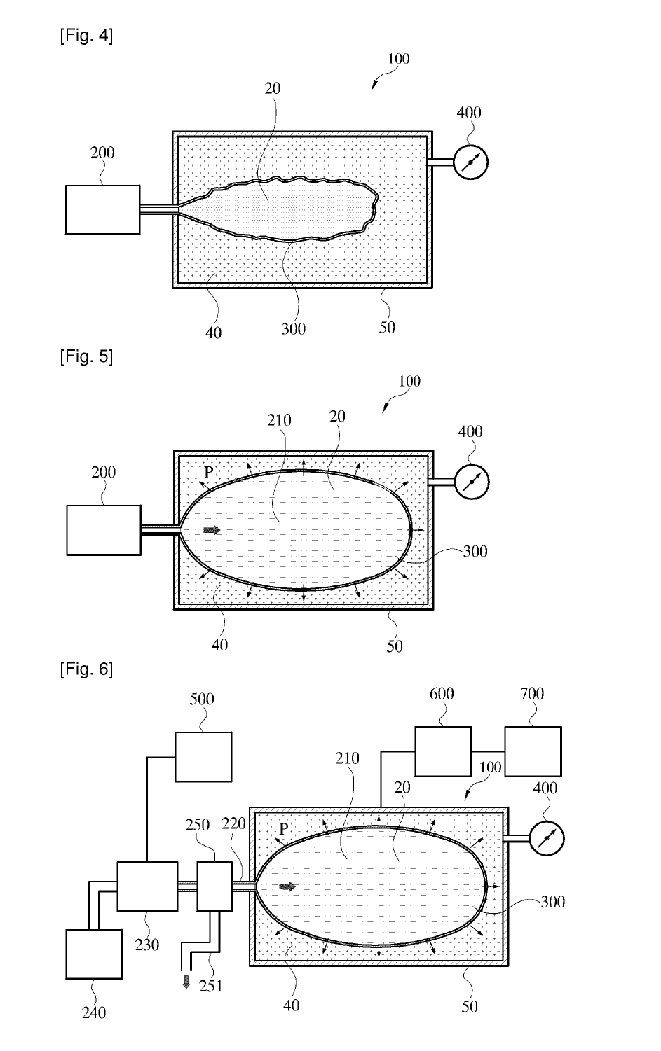

Hereinafter, an explanation on the configuration of a device 100 for testing resist pressure of a vessel according to preferred embodiments of the present invention will be given. FIG. 4 is a sectional view showing the device 100 for testing resist pressure of a vessel according to a first embodiment of the present invention. As shown, the testing device 100 according to the first embodiment of the present invention includes a vessel 50, an elastic tube 300 into which a liquid 20 is filled, a pressurizing means 200 adapted to put an injection liquid 210 into the elastic tube 300, and a pressure gauge 400 adapted to gauge a pressure into the vessel 50.

The vessel 50 as an object to which a resist pressure test is performed does not have any limitation in the shape, and the vessel 50 which is manufactured to its real use shape is used. The vessel 50 is a gas-storing vessel. Accordingly, a gas 40, which is stored at a high compressed state in the real use of the vessel 50, is filled into the vessel 50. In the preferred embodiment of the present invention, the vessel 50 is a hydrogen-storing vessel, and the gas 40 stored into the vessel 50 is hydrogen.

Further, as shown in FIG. 4, the elastic tube 300 is disposed in the interior of the vessel 50 in which the hydrogen gas 40 is filled. Accordingly, the hydrogen gas 40 is filled into the space between the exterior of the elastic tube 300 and the interior of the vessel 50. A quantity of hydrogen gas filled into the space corresponds to a maximum quantity of hydrogen gas limited in the resist pressure test. The hydrogen has a good compressive force, but has an explosive danger during the test, such that the quantity of hydrogen should be limited during the test. Since the elastic tube 300 is disposed in the interior of the vessel 50, thus, the resist pressure test can be carried out in the same environment as the real use conditions of the vessel 50, with a relatively small quantity of low pressure hydrogen.

Also, the elastic tube 300 has the liquid 20 filled thereinto. In the first embodiment of the present invention, the liquid 20 is water, but if the liquid 20 does not react with the injection liquid 210 put into the elastic tube 300, the kinds of liquids are not limited thereto. However, it is desirable that the liquid 20 having a low compressive force is used. The elastic tube 300 is made of a material having elasticity and high durability relative to the pressure caused during the putting operation of the injection liquid 210. For example, the elastic tube 300 is formed of a rubber tube, polydimethylsiloxane (PDMS), polyurethane, a material made by combining them, or the like. If the material has high resist pressure and a predetermined elastic force, the kinds of materials are not limited thereto.

Further, the pressurizing means 200 is provided to apply a pressure to the interior of the elastic tube 300 so as to make the elastic tube 300 expanded. As shown in FIG. 4, the pressurizing means 200 is provided at the outside of the vessel 50 and is adapted to put the injection liquid 210 into the elastic tube 300. FIG. 5 is a sectional view showing a state wherein the elastic tube 300 is expanded by means of the pressurizing means 200 in the testing device 100 according to the first embodiment of the present invention. As shown in FIG. 5, the pressurizing means 200 puts the injection liquid 210 into the elastic tube 300. Between the elastic tube 300 and the pressurizing means 200 is provided a gasket, an O-ring, or the like (which is not shown) so as to prevent the leakage of the liquid 20 or prevent the gas 40 in the vessel 50 from flowing to the pressurizing means 200. Also, on the portion where an injection pipe 220 and the vessel 50 are coupled to each other is provided a gasket, an O-ring, or the like (which is not shown).

The pressurizing means 200 is composed of a pump 230, and if the injection liquid 210 is made of a material which does not react with the elastic tube 300 and the liquid 20 filled into the elastic tube 300, the kinds of injection liquids are not limited. As the injection liquid 210 is put into the elastic tube 300, the elastic tube 300 becomes expanded.

As the elastic tube 300 is expanded, the hydrogen gas filled into the vessel 50 becomes compressed. Thus, a pressure P in the vessel 50 becomes increased. As the hydrogen gas is compressed, as shown in FIG. 5, the vessel 50 receives the pressure P, and the pressure P is acted in the state where the internal surface of the vessel 50 is brought into contact with the hydrogen gas, in the same manner as in the real use. Accordingly, it can be checked that what degree of pressure P causes the deformation of the vessel 50. At the same time, it can be measured that what degree of hydrogen embrittlement by the hydrogen gas occurs on the vessel 50 or hydrogen leakage occurs from the vessel 50.

Also, the pressure gauge 400 is adapted to gauge the pressure P into the vessel 50. Thus, it can be checked in real time that what degree of pressure P in the vessel 50 is applied as the elastic tube 300 is expanded by means of the pressurizing means 200. The resist pressure test of the vessel 50 is desirably carried out at a higher pressure by 1.0 times to 1.8 times than the pressure applied to the hydrogen-storing vessel 50 in the real use thereof.

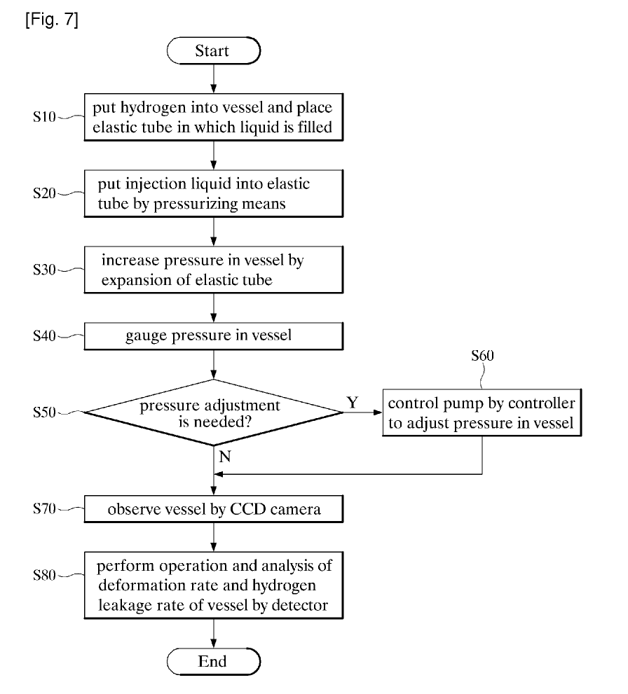

FIG. 6 is a sectional view showing a device for testing resist pressure of a vessel according to a second embodiment of the present invention. As shown in FIG. 6, in the same manner as in the first embodiment of the present invention, the testing device 100 according to the second embodiment of the present invention includes a vessel 50 as an object to which a resist pressure test is performed, a gas 40 filled into the vessel 50, an elastic tube 300 into which a liquid 20 is stored, and a pressurizing means 200. Further, the testing device 100 according to the second embodiment of the present invention includes a measuring means 600, a detector 700 and a controller 500.

In the second embodiment of the present invention, the pressurizing means 200 further includes an injection pipe 220, a pump 230, a tank 240, and the controller 500 for adjusting the pressure of the pump 230. The pump 230 serves to compress the liquid stored in the tank 240 and to put an injection liquid 210 into the elastic tube 300 through the injection pipe 220. The pressure of the pump 230 is in a range between 1 Mpa and 250 Mpa. The controller 500 controls the pump 230 to control the pressure in the vessel 50 such that the pressure reaches a higher pressure by 1.0 times to 1.8 times than the pressure applied to the vessel 50 in the real use.

In the second embodiment of the present invention, further, the vessel 50 to which a pressure is applied is measured by means of the measuring means 600 provided at the exterior of the vessel 50. Accordingly, the degrees of deformation and hydrogen leakage of the vessel 50 caused by the internal pressure of the vessel 50 are measured by means of the measuring means 600. The measuring means 600 is composed of a strain gauge, a gas detector and the like. The measuring means 600 is connected to the detector 700. The detector 700 serves to carry out the operation of the deformation rate and the hydrogen leakage rate of the vessel 50 with respect to the current internal pressure observed by means of the measuring means 600. The detector 700 is provided with a computer or the like in which a program performing the operation of the deformation rate and the hydrogen leakage rate is stored.

Further, the testing device 100 according to the second embodiment of the present invention includes a cut-off part 250 connected to the pump 230. The cut-off part 250 is controlled by the controller 500. The above-mentioned detector 700 is connected to the controller 500. The detector 700 stores a critical deformation rate and a hydrogen leakage standard previously set in accordance with the types of the vessel 50 therein. Through the detector 700, accordingly, it is determined whether a current deformation rate caused by the internal pressure of the vessel 50 is more than the critical deformation rate set previously, and alternatively, it is determined whether a current hydrogen leakage rate is more than the hydrogen leakage standard set previously. If so, the cut-off part 250 is operated by means of the controller 500 to stop the putting operation of the injection liquid 210, so that the injection liquid 210 put into the elastic tube 300 is discharged through a discharge outlet 251.

<Method for Testing Resist Pressure of Vessel>

Hereinafter, an explanation on a method for testing resist pressure of a vessel according to a preferred embodiment of the present invention. First, FIG. 7 is a flow chart showing a method for testing resist pressure of a vessel according to a preferred embodiment of the present invention. The elastic tube 300 in which the liquid 20 is stored is disposed in the interior of the vessel 50 as an object to which a resist pressure test is carried out, and a low pressure hydrogen gas is filled into the space formed between the vessel 50 and the elastic tube 300 (at step S10).

Next, the pressurizing means 200 is connected to the elastic tube 300 to put the injection liquid 210 into the elastic tube 300 (at step S20). The pressurizing means 200 is operated wherein the liquid 40 stored in the tank 240 is pressurized by means of the pump 230 and is then put into the elastic tube 300 through the injection pipe 220. The elastic tube 300 into which the injection liquid 210 is put is expanded. Then, as the elastic tube 300 is expanded, the hydrogen filled into the vessel 50 becomes compressed, and the pressure in the vessel 50 is also increased (at step S30).

The pressure gauge 400 gauges the pressure in the interior of the vessel 50 in real time (at step S40). Accordingly, the pressure in the interior of the vessel 50 caused by the expansion of the elastic tube 300 is checked by a user. Further, it is checked whether the pressure in the interior of the vessel 50 is a pressure required for the resist pressure test of the vessel (at step S50). Thus, if the current pressure in the interior of the vessel 50 gauged by the pressure gauge 400 is different from the pressure required for the resist pressure test, the pressure of the pump 230 is controlled by means of the controller 500 (at step S60).

With the control of the pressure of the pump 230 by the controller 500, the degree of expansion of the elastic tube 300 is adjusted. Accordingly, the pressure in the interior of the vessel is adjusted to a desired pressure. Then, if the pressure required for the resist pressure test has been set, the vessel 50 is observed through the measuring means 600 provided to the outside of the vessel 50 (at step S70). That is, the deformation rate and the gas leakage rate of the vessel 50 caused by the internal pressure of the vessel 50 are observed through the measuring means 600. The detector 700 is connected to the measuring means 600 so as to perform the operation of the deformation rate and the hydrogen leakage rate of the vessel 50. The observation of the measuring means 600 and the operation of the deformation rate and the hydrogen leakage rate of the detector 700 are carried out continuously during the pressure is applied to the vessel 50.

The deformation rate and hydrogen leakage rate set previously are stored in the detector 700. Accordingly, it is determined whether the deformation rate of the vessel 50 obtained by the operation of the detector 700 is more than the deformation rate set previously, and alternatively, it is determined whether the hydrogen leakage occurs from the vessel 50. If so, the cut-off part 250 is operated by means of the controller 500. As a result, the putting operation of the injection liquid 210 into the elastic tube 300 stops, and the injection liquid 210 put into the elastic tube 300 is discharged through the discharge outlet 251.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A device for testing resist pressure of a vessel, the device comprising:
the vessel provided as an object to which a resist pressure test is carried out;
an elastic tube placed in the interior of the vessel and adapted to fill a liquid into the interior thereof;
a pressurizing means adapted to apply a predetermined pressure to the elastic tube to allow the elastic tube to be expanded; and
a pressure gauge adapted to gauge the pressure in the interior of the vessel,
wherein a gas is filled into a space between the interior of the vessel and the exterior of the elastic tube to apply a predetermined pressure to the interior of the vessel by the expansion of the elastic tube.

2. The device for testing resist pressure of a vessel according to claim 1, wherein the gas is hydrogen.

3. The device for testing resist pressure of a vessel according to claim 2, wherein the vessel is a hydrogen-storing vessel.

4. The device for testing resist pressure of a vessel according to claim 1, wherein the pressurizing means expands the elastic tube by putting an injection liquid into the elastic tube.

5. The device for testing resist pressure of a vessel according to claim 1, wherein the elastic tube is formed of a rubber tube, a polymer elastomer, or the like.

6. The device for testing resist pressure of a vessel according to claim 4, wherein the pressurizing means comprises a tank adapted to storage the injection liquid to be put into the elastic tube therein, a pump adapted to compress the injection liquid stored in the tank and to put the injection liquid into the elastic tube, and an injection pipe adapted to connect the pump and the elastic tube.

7. The device for testing resist pressure of a vessel according to claim 6, wherein the injection liquid is an incombustible liquid and does not react with the tank, the pump, the injection pipe and the elastic tube.

8. The device for testing resist pressure of a vessel according to claim 7, wherein the pressure of the pump is in a range between 1 Mpa and 250 Mpa.

9. The device for testing resist pressure of a vessel according to claim 6, wherein the pressurizing means further comprises a controller adapted to control the pump to adjust the pressure in the vessel.

10. The device for testing resist pressure of a vessel according to claim 9, wherein a measuring means is connected to the exterior of the vessel to measure and observe the state of the vessel.

11. The device for testing resist pressure of a vessel according to claim 10, wherein a detector is connected to the measuring means to perform operation and analysis of a deformation rate and a gas leakage rate of the vessel caused by the pressure of the gas.

12. The device for testing resist pressure of a vessel according to claim 11, wherein a cut-off part is provided to cut off the putting operation of the injection liquid into the elastic tube and has a discharge outlet adapted to discharge the injection liquid put into the elastic tube therethrough.

13. The device for testing resist pressure of a vessel according to claim 12, wherein if the deformation rate obtained by the operation of the detector is more than a critical deformation rate set previously, and alternatively, if the gas leakage rate obtained by the operation of the detector is more than a gas leakage standard set previously, the cut-off part is operated by the controller to stop the putting operation of the injection liquid into the elastic tube.

14. A method for testing resist pressure of a vessel, the method comprising the steps of:
filling a gas into the vessel provided as an object to which a resist pressure test is carried out and placing an elastic tube in which a liquid is stored in the interior of the vessel;
connecting the elastic tube and a pressurizing means and putting an injection liquid into the elastic tube by means of the pressurizing means to expand the elastic tube;
compressing the gas filled into the vessel to increase a pressure in the interior of the vessel;
gauging the pressure in the interior of the vessel by means of a pressure gauge; and
repeatedly increasing and decreasing the pressure of the injection liquid in the elastic tube to apply repeated load to the vessel.

15. The method for testing resist pressure of a vessel according to claim 14, wherein the gas is hydrogen and the vessel is a hydrogen-storing vessel.

16. The method for testing resist pressure of a vessel according to claim 14, wherein in the step of expanding the elastic tube the injection liquid stored in a tank is compressed by means of a pump and put into the elastic tube through an injection pipe.

17. The method for testing resist pressure of a vessel according to claim 16, wherein the pump is controlled by means of a controller to adjust the pressure in the interior of the vessel.

18. The method for testing resist pressure of a vessel according to claim 17, wherein the step of gauging the pressure in the interior of the vessel further comprises the step of measuring and observing the vessel through a measuring means connected to the exterior of the vessel.

19. The method for testing resist pressure of a vessel according to claim 18, wherein the step of gauging the pressure in the interior of the vessel further comprises the step of performing operation and analysis of a deformation rate and a gas leakage rate of the vessel caused by the pressure of the gas through a detector connected to the measuring means.

20. The method for testing resist pressure of a vessel according to claim 19, wherein if the deformation rate obtained by the operation of the detector is more than a critical deformation rate set previously, and alternatively, if the gas leakage rate obtained by the operation of the detector is more than a gas leakage standard set previously, the putting operation of the injection liquid into the elastic tube stops by means of a cut-off part operated by the controller.
